(19) United States
(12) Patent Application Publication
(10) Pub. No.: US 2009/0128090 A1
(43) Pub. Date: May 21, 2009

(54) Portable charger for consumer electronic devices

(76) Inventor: Gang Bi, Grayslake, IL (US)

Correspondence Address: GANG BI, 34339 N. Bobolink Trail, Grayslake, IL, 60030, US

(21) Appl. No.: 11/986,506

(22) Filed: Nov. 21, 2007

(51) Int. Cl. H02J 7/00; H04H 20/48

(52) U.S. Cl. 320/103; 381/14

(57) ABSTRACT

Disclosed herein is a portable charger for mobile phones and other consumer electronic devices like iPOD, MP3 players, etc. The portable charger is a plug-and-charge device, it includes both male and female connectors, built-in rechargeable Li-Polymer or Li-Ion battery, LED and ON/OFF button. USB-flash-drive like design with cap covering male connector, lightweight enough to be attached to a key chain, when is needed, it can be plugged into Cell phone or other portable devices to charge devices right away. In various embodiments, different functionalities are added: utility light, MP3 player, FM radio transmitter, FM radio receiver, Bluetooth audio adapter, voice recorder, USB flash drive.

### CROSS-REFERENCE TO RELATE APPLICATIONS

US patent documents

| | | | |
|---|---|---|---|
| 7,166,987 B2* | January 2007 | Lee at al | 320/114 |
| 6,733,329 B2* | May 2004 | Yang | 439/518 |
| US 2007/0159133 A1* | | Kang et al | 320/107 |
| US 2006/0131431 A1* | | Finn | 235/492 |
| US 2005/0046384 A1* | | Simoes et al | 320/114 |

### FIELD OF THE INVENTION

The invention discloses a portable charger for charging cell phone or other portable consumer electronics on-the-go, more particular, it is USB-flash-drive like, it is lightweight enough to be attached to user's key chain or carried in user's pocket.

### RELATED ART

Cell phone charger and portable cell phone charger is already known. Originally wall charger or travel charger can only be used for charging cell phones. Wall charger is typically connecting one end to wall outlet, connecting the other end to cell phone.

Since more and more applications, especially multimedia application running on cell phones, the battery-power of cell phone can be consumed very quickly, same situation occurs for other consumer electronics devices, like portable mp3 players (Apple iPOD, Sandisk Sansa, etc.), portable game players (like Sony PSP, Nintendo DS Lite), Cell phone Bluetooth headset, etc.

To meet this power demand, portable power is developed. More popular one is the portable charger which is using one or two AA batteries, lithium, rechargeable or alkaline. One example is “Energi To Go™” cell phone charger from Energizer Holdings, Inc. The design for this type of portable charger is usually has a generic socket for all consumer devices, to charge different devices, separate adapters has to be purchased. For example, to charge Nokia N95 cell phone, a separate adapter for N95 is needed. For charging, user will need to plug one end of the adapter into the power generic socket; then attach the other end of the adapter into cell phone's charging port. To use this type of charger, user has to carry both power station and separate adapter, it is usually not convenient for carrying both parts and putting them together when charging is needed.

The other type of portable charger is Motorola P790, which has a retractable Mini-USB male adapter with built-in recharging Li-Ion/Li-Polymer battery. Since the implementation of the retractable mechanism occupying mechanical space in the housing, thus the implementation can not make the charger small and lightweight enough. Since the retractable male Mini-USB adapter is not mounted in the housing in fixed position, it can easily getting loose when user is trying to plug it into cell phone's female socket. User will feel the connection is wiggling.

### SUMMARY OF THE INVENTION

It is the primary object of the present invention is to solve above problem and provide a new portable charger. The shape and size of charger is very similar with a conventional USB flash drive which is small and lightweight enough to be attached to a key chain. It includes both male and female connectors. Female connector is used to charge portable charger itself, which is charging the built-in Lithium Polymer or Lithium-ion battery. Male connector is used for output to charge cell phone etc. consumer electronics. For preventing the male connector exposing outside of the housing, one cap is designed to cover the male connector.

### BRIEF DESCRIPTION OF THE DRAWINGS

FIG. 1 is a diagram of an embodiment of this invention for Blackberry/Motorola RAZR compatible cell phones.

FIG. 2 is a diagram of an embodiment of this invention for Nokia N95 compatible cell phones.

FIG. 3 is a diagram of an embodiment of this invention for Nokia N95 compatible cell phones, with cap covered.

FIG. 4 is a circuit block diagram of a preferred embodiment of the present invention.

FIG. 5 is a detailed circuit diagram of one embodiment of the present invention.

FIG. 6 is a detailed circuit diagram of one preferred embodiment of the present invention.

### DETAILED DESCRIPTION OF THE INVENTION

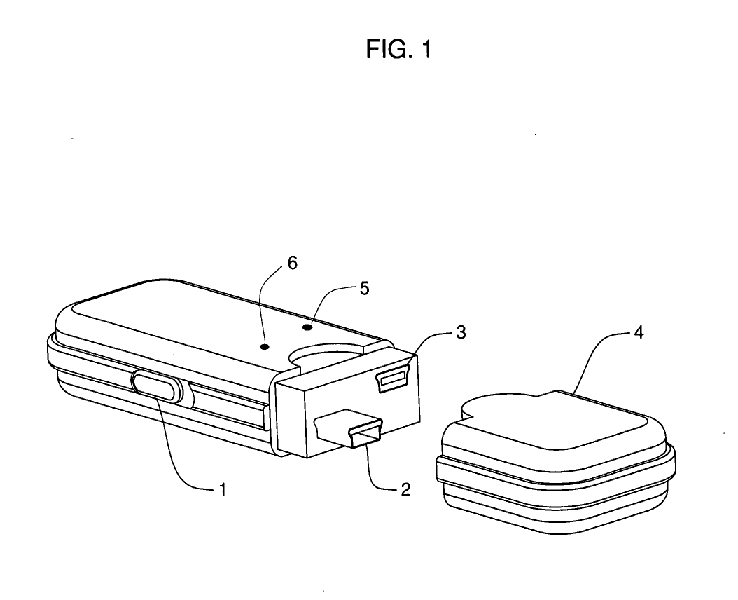

FIG. 1 illustrates the charger for Motorola RAZR compatible cell phones, with cap 4 uncovered.

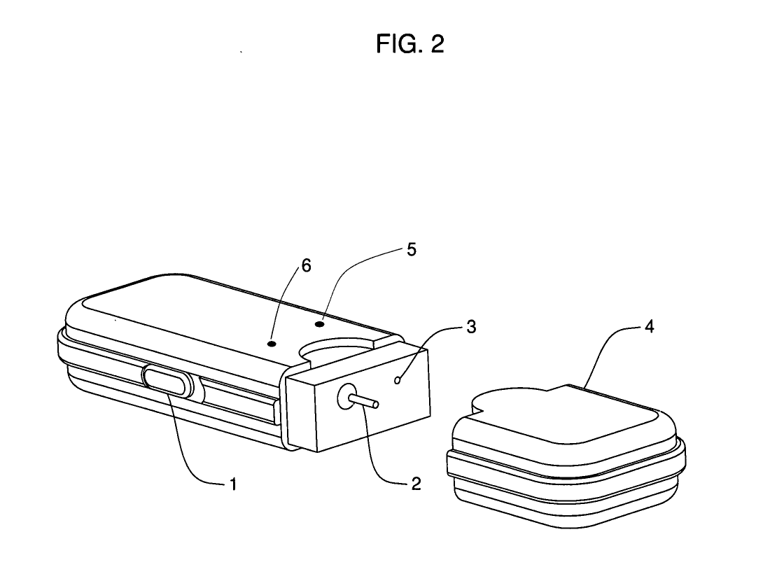

On FIG. 1, user can use the existing wall Mini-USB charger for charging RAZR phone to charge the portable charger itself. 3 is the female connector which is used for changing the charger itself, when user purchased a cell phone, home wall charger or travel charger will be provided together with cell phone, so user just needs to plug the existing wall Mini-USB charger to 3 for charging. Connector 2 is the male connector used for plugging into RAZR or Blackberry to charge these cell phones or other Mini-USB compatible devices. On FIG. 1, user can use existing Mini-USB home wall charger to plug to the female connector 3 to charge the portable charger itself. For N95, user just needs to use the existing wall/travel charger accompanied for N95 to charge the portable charger itself. On FIG. 1 and FIG. 2, two LEDs are used. In this embodiment, after wall charger is plugged into female connector 3 and self-charging begins, LED 5 is turned on; when self-charging is completed, LED 5 will turn off. In other embodiments, one LED which different color can be used or LCD can be used as an alternative.

When cell phone or consumer electronics need power, user can turn on the charger by sliding the switch 1 to “ON” position, the other LED 6 is turned on which means this portable charger is ready for charging other device, by plugging male connector to cell phone or other consumer electronics, cell phone or consumer electronics will recognize it as a charger and initiate the charging process.

Since the nature of this design is lightweight and small enough, whenever the power is needed, user can just open the cap and have the charger plugged into consumer electronics.

Especially when using a cell phone, in a phone call and battery is low, plugging in this portable charger is very helpful to continue phone call conversation.

Since inside the portable charger Li-Ion or Li-polymer battery is used, to protect the portable charger is over discharged, protection circuit will shutdown the current drain when the voltage level is below a threshold (2.7V-3.0V). LED 6 will be turned off which indicates the internal battery of the portable charger is very low, it has to be re-charged for using next time.

FIG. 2 illustrates the charger for Nokia N95 compatible cell phones, with cap 4 uncovered. Similar with FIG. 1, user can use his/her existing travel charger to charge the portable charger.

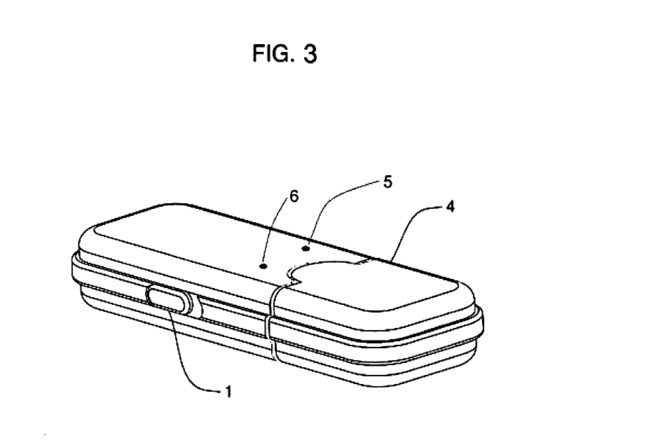

FIG. 3 illustrates the charger for Nokia N95 compatible cell phones, with cap 4 covered, since the male connector on the charger is covered by a cap, the charger can be conveniently carried in user's pocket or attached in a keychain to carry.

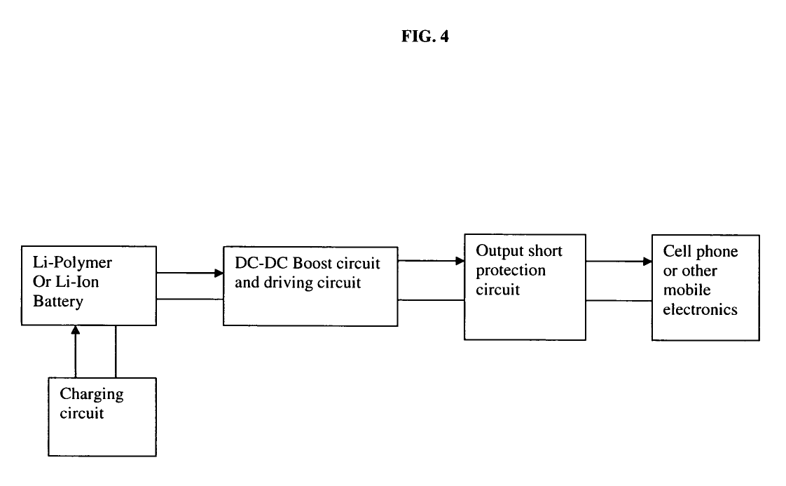

FIG. 4 illustrates a circuit block diagram of a preferred embodiment of the present invention. In this illustration, LTC4065 is the charging IC for Li-polymer or Li-Ion battery, the input is from +3.75V to 5.5V with maximum of 750 mA charging current. MAX1797 is the step-up DC-DC converter, its output is in the range of +2V to +5.5V, its input is in the range of +0.7V to Vout. Both charging circuit and DC-DC converter are connecting to Li-polymer battery, since Max 1797 is powerful for output functionality, other circuit required is minimized.

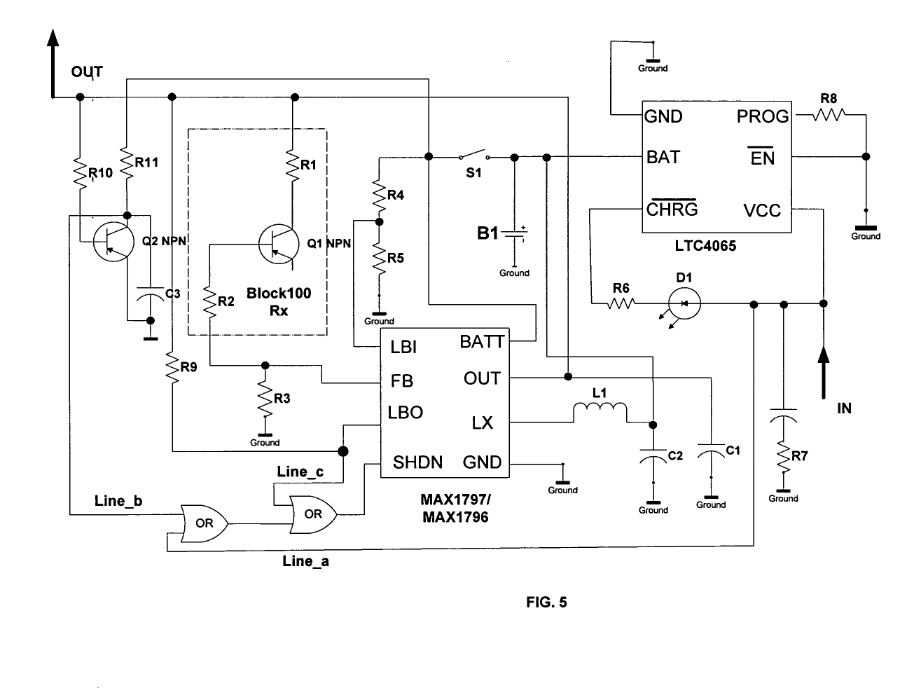

FIG. 5 illustrates a detailed circuit of one embodiment of the present invention. Block 100 includes R1, R2 and NPN transistor Q1, this block and R3 acts as resistive voltage-divider from OUT to GND to adjust the output voltage. In Block 100, R1 connects one of its end to OUT, connects the other end to Q2's collector, R2 connects one of its end to Q2's base, connects the other end to R3 (FB pin). R3 connects one of its end to FB pin of MAX1797, connects the other end to Ground. Block 100 can be considered an equivalent resistor Rx, so basically Rx and R3 acts a voltage-divider. Q1's emitter is not connected. In the preferred embodiment, the output voltage is setting to around 5.0V which is a standard value for majority of consumer electronics chargers. In this embodiment, Q1 is a NPN bipolar transistor for improving current amplification and sensing, for those familiar with this art, PNP bipolar transistor can be also used as well as MOSFET transistors.

Output short circuit protection comprises Q2, R10, R11 and C3. R10 connects one end to output, connects the other end to Q2's base, R11 connects one end to Q2's collector, connects the other end to battery voltage which can be turned on/off by a switch. C3 acts as a delay capacitor. When output is shorted to ground, voltage on Q2's base is close to 0V which cause Q2 off, Q2 collector voltage will be increased eventually because of C3, when it reaches the threshold voltage for one input of line_b of OR gate, OR gate will output logic “1” which subsequently apply logic “1.” to the “SHDN” pin thus shutdown Max1797. In this case, after Max1797 is shutdown, removing external load's shorting condition does not resume the output of Max1797. Max1797's output can only resumed by turn off switch S1 and then turn it back ON.

In this embodiment, as a protection, when self-charging is started, the output of this portable charger is not allowed. Basically one input of OR gate (Line_a) connects external charger's input, when external wall charger is connected, when external charger is plugged for self-charging, Line_a turns to HIGH, which also makes OR gate output HIGH, thus shutdown MAX1797 IC.

R4, R5, R9, OR gate, as well as LBI, LBO and SHDN pins, working together for detecting low-battery and shutdown the IC. Low-battery monitor threshold is set by two resistors R4 and R5, before this threshold is detected; LBO is an open-drain output which sinks current to Ground. When this low-battery threshold is detected, LBO goes high impedance, since R9 connecting to output as a pull-up resistor, Line_b becomes HIGH which subsequently makes OR gate output HIGH. OR gate output connects to the SHDN pin of MAX1797, output HIGH from OR gate will shutdown the MAX1797.

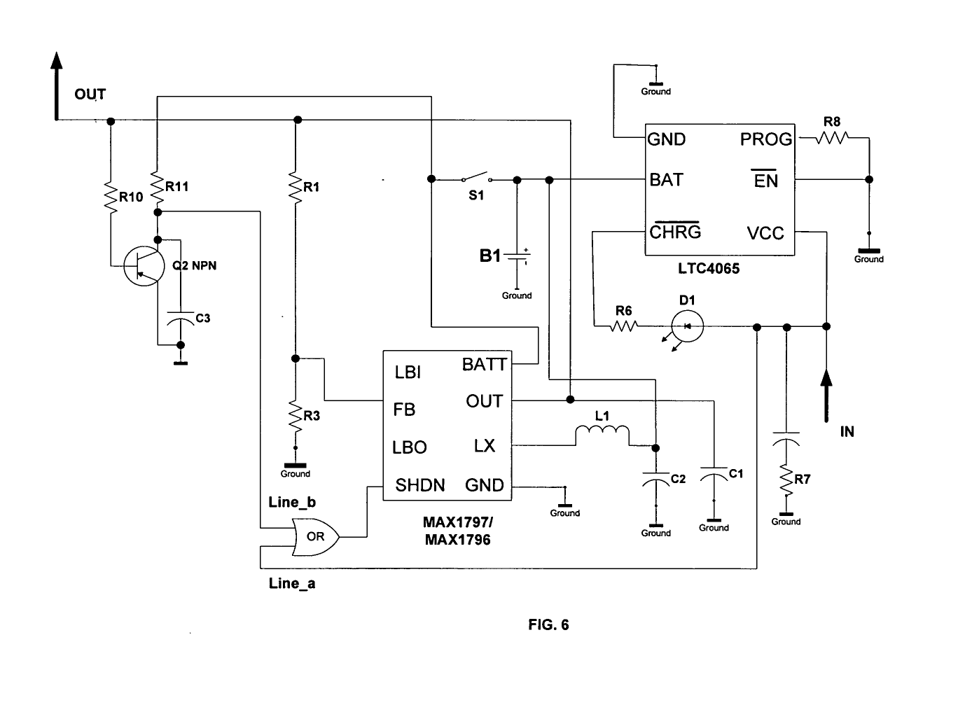

FIG. 6 illustrates a detailed circuit of the preferred embodiment of the present invention. It is a simplified embodiment based on previous embodiment on FIG. 5. From this illustration, self-charging IC LTC4065 connects to Li-polymer battery B1 directly, DC-DC boost MAX1797 connects to Li-polymer battery B1 through a switch S1.

In this embodiment, low battery detection circuit is removed, it is usually for the case when low battery detection circuit or over-discharging circuit is protected in part of Li-ion or Li-polymer battery. Only one OR gate is presented in this illustration. Same as FIG. 5, output short circuit protection comprises Q2, R10, R11 and C3. When output is shorted to ground, Line_b turns to HIGH, thus shutdown Max1797.

R1 and R3 acts as a voltage-divider to control the output voltage value.

Line_a connects to input line of external charger, when external charger is presented, Max1797 will be shutdown to disable output.

In some embodiments, a light is also included in the body, which is powered through internal Li-polymer or Li-Ion battery. This light is basically a white LED which can be used as a utility light when user is in dark to search keys, etc.

In some embodiments, FM radio transmitter functionality is included. Basically additional circuit is added on the portable charger PCB, it takes the input audio data which is available from the bus (Mini-USB or iPOD/iPhone 30-pin bus connector), then converts it into FM signal, then utilize a user customized frequency/channel to transmit so short-range of receiver can receive it. One application is that when user plug the portable charger into iPOD/iPhone to charge the iPOD/iPhone, at the same time, mp3 sound can be routed through the Audio path from iPOD/iPhone 30-pin connector and FM circuit in the portable charger can take this audio samples and convert it to FM signal, so playing music using the iPOD/iPHONE, music can be heard through FM radio when user sitting in a car and selecting the specific FM channel. There will be separate keys for browsing/setting the FM frequency. In some embodiments, a LCD is included in the body for displaying the user-selected FM frequency.

In some embodiments, FM radio receiver functionality is included. Basically additional circuit is added on the portable charger's PCB, it can receive the FM signal and decode it. User is able to hear FM radio broadcasted in the air through headset or speaker. Buttons will be provided for users to select/browse FM channel. In some embodiments, a LCD is included in the body for displaying the user-selected FM channel.

In some embodiments, Bluetooth audio adapter functionality is also included. Basically additional circuit is added on the portable charger PCB, it takes the input audio data which is available from the data bus of male connector (Mini-USB or iPOD 30-pin bus connector), converts it into Bluetooth signal, the adapter supports either A2DP (Advanced Audio Distribution Profile) or HSP (Headset Profile). One application is that when user plugs the portable charger into iPOD, at the same time, mp3 sound can be routed through the Audio path from iPOD 30-pin connector and Bluetooth related circuit in the portable charger can take this audio samples and convert it to Bluetooth signal, so playing music using the iPOD, music can be heard by user wearing a Bluetooth stereo headset.

Also in some embodiments, a MP3 player functionality is also included in the body, in such embodiments, the MP3 player is energizing through internal Li-polymer or Li-Ion battery, with internal flash memory for storing MP2 songs, external buttons for browsing songs as well as playing, stopping and pausing functionality for a portable player.

Also in some embodiments, voice recorder functionality is also included in the body, in such embodiments, the voice recorder is energizing through internal Li-polymer or Li-Ion battery, with internal flash memory for storing the voice data. External buttons are provided for playing the recorded data as well as browsing, deleting, etc. functionality.

Also in some embodiments, USB drive functionality is included. The portable chargers has a standard USB type-A plug which can connect said device to computer directly for data transfer as well as self-charging, one switch is needed to switch the charger working as a USB flash drive or working as portable charger. Flash memory is included embedded inside in the PCB as storage.

What claimed is:

1. A portable charging device for consumer electronics comprising:
A built-in recharging Lithium Polymer or Lithium-ion battery and built-in circuit board; both male and female connectors, said female connector being used for charging the said device, said male connector being used for output to charge consumer electronics; at least one cap being in use for covering said male connector;
or covering both said male connector and said female connector.

2. The portable charging device as recited in claim 1 wherein said male connector is referring to the connector on travel charger which is usually accompanied with rechargeable consumer electronics, said male connector is also referring to DC plug in some embodiments; said female connector is referring to the charging socket exist on rechargeable consumer electronics, said female connector is also referring to the DC jack on rechargeable consumer electronics in some embodiments.

3. The portable charging device as recited in claim 1 wherein said male connector is attached the said device body, said male connector is not retractable.

4. The portable charging device as recited in claim 1 wherein said cap will be either plastic material or metal material.

5. The portable charging device as recited in claim 1 wherein said output short circuit protection comprises transistor Q2, resistors R10 and R11, capacitor C3. R10 connects one end to output, connects the other end to transistor's base. R11 connects one end to transistor's collector, connects the other end to battery's plus which can be turned on/off by a switch. Capacitor C3 connects one end to collector, connects the end to ground. Transistor's emitter connects to ground. Transistor's collector connects to DC-DC converter's SHDN pin or through logic gates (OR gate, NOT gate or NOR gate) connects to the SHDN pin.

6. The portable charging device as recited in claim 1 wherein said output current sense improvement circuit (Block 100) comprises a transistor Q1, two resistors R1 and R2. R1 connects one end to output, connects the other end to transistor's collector. R2 connects one end to transistor's base, connects the other end to DC-DC converter FB pin.

7. The portable charging device as recited in claim 1 wherein said low-battery detection and control circuit comprises R4, R5, R9, LBI pin, LBO pin and SHDN pin. R4 connects one end to battery's plus which can be turned on/off by a switch, connects other end to LBI pin, R5 connects one end to LBI pin, connects the other end to ground. R9 connects one end to output, connects the other end to LBO pin, LBO connects to DC-DC converter's SHDN pin or connects SHDN pin through a logic gate (OR gate, NOT gate or NOR gate).

8. The portable charging device as recited in claim 1 wherein said DC-DC converter is shutdown when external charger is plugged for self-charging, wherein said Line_a connects to SHDN pin or through an OR gate connects to SHDN pin.

9. The portable charging device as recited in claim 1 wherein said DC-DC converter used in preferred embodiment is Max1797. Max1796 or LTC3424 is used in some embodiments.

10. The portable charging device as recited in claim 1, in some embodiments, FM transmitter functionality is included. Said FM transmitter takes audio data from the audio path routed to the said male connector and transmit the audio data into FM signal.

11. The portable charging device as recited in claim 1, in some embodiments, FM receiver functionality is also included. Said FM receiver receives FM radio signal broadcasted in the air and decodes it. User can use headset jack or speaker built-in said portable charging device to hear FM radio.

12. The portable charging device as recited in claim 1, in some embodiments, Bluetooth audio adapter functionality is included. Said Bluetooth adapter takes audio input from the audio path routed to the said male connector and transmits the audio data into Bluetooth signal. Said Bluetooth adapter supports either A2DP (Advanced Audio Distribution Profile) or HSP (Headset Profile).

13. The portable charging device as recited in claim 1, in some embodiments, MP3 player functionality is included. Said MP3 player is powered from said internal Li-Ion or Li-Polymer battery, MP3 data will be loaded into internal flash memory mounted in PCB through Mini-USB connector. Said MP3 player can play common digit music in format like MP3, WAV, WMA, QT, RAM, RA.

14. The portable charging device as recited in claim 1, in some embodiments, utility light functionality is included. Said utility light is powered from said internal Li-Ion or Li-Polymer battery.

15. The portable charging device as recited in claim 1, in some embodiments, voice recorder functionality is included. Said voice recorder is energizing through internal Li-polymer or Li-Ion battery, with internal flash memory mounted in PCB for storing the voice data. External buttons is provided for playing the recorded data as well as browsing, deleting.

16. The portable charging device as recited in claim 1, in some embodiments, USB drive functionality is included. Said USB flash drive has a standard USB type-A plug which can connect said device to computer directly. Said USB drive's flash memory is included in said device's circuit.
